(19) United States
(12) Patent Application Publication
(10) Pub. No.: US 2009/0127904 A1
(43) Pub. Date: May 21, 2009

(54) Seat Structure, Seat Extension/Retraction Method and Vehicle

(76) Inventors: Masayuki Yamada, Aichi (JP); Hideki Kobayashi, Aichi (JP); Takeshi Toukai, Aichi (JP); Masaki Mori, Gifu (JP); Keisuke Onoda, Aichi (JP); Makoto Ito, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/083,613

(22) PCT Filed: Oct. 17, 2006
(86) PCT No.: PCT/JP2006/320648

§ 371 Date: Apr. 15, 2008

(30) Foreign Application Priority Data
Oct. 17, 2005 (JP) 2005-301640

(51) Int. Cl. A47C 3/00; B60N 2/64; B60N 2/20; B60N 2/02; A47C 4/04

(52) U.S. Cl. 297/284.1

(57) ABSTRACT

In a seat (10), rotating a seat cushion rearward causes the seat cushion to be superposed on the front side of a seat back for stowage. In the stowage of the seat (10), the seat cushion is rotated rearward, moving an interlocking link downward. The connection link (18) is then rotated downward in the seat back, so that a distance in a back-and-forth direction between a back main frame (14) and a receiving member (20) is reduced. This allows the thickness of the seat back (12) to be reduced in a part on the back of the back main frame (14).

### TECHNICAL FIELD

The present invention relates to a seat structure and a seat extension/retraction method, which are capable of extending and retracting the thickness of a seat back, and a vehicle comprising the seat structure.

### BACKGROUND ART

As a seat structure, proposed has been one in which a back panel is provided on the back side of a seat back so that a clearance between the seat back and the back panel would be adjustable (refer to Patent Reference 1, for example).

In the above seat structure, however, the clearance between the seat back and the back panel can be adjusted only in tilting the seat back forward and returning the seat back from the tilted state.

Patent Reference 1: JP-A-2002-264708

### DISCLOSURE OF THE INVENTION

In view of the above, an object of the invention is to achieve a seat structure, a seat extension/retraction method and a vehicle, which are capable of extending and retracting the thickness of a seat back even at the time other than the time of tilting the seat back forward and returning the seat back from the forward tilt.

A seat structure according to claim 1 comprises: a main frame member provided in a seat back; an extending/retracting unit including a secondary frame member provided at a surface side or a back side of the main frame member in the seat back and a link rotatably connected to the main frame member and the secondary frame member; and a link mechanism connected to a seat cushion and the extending/retracting unit, whereby the link is rotated together with a rotation of the seat back with respect to the seat cushion.

In the seat structure according to claim 1, the main frame member is provided in the seat, back. Further, the extending/retracting unit includes the secondary frame member and a link. The secondary frame member is provided at the surface side or the back side of the main frame member in the seat back while the link is rotatably connected to the main frame member and the secondary frame member.

In the above case, the link mechanism is connected to the seat cushion and the extending/retracting unit and the link is rotated together with the rotation of the seat back with respect to the seat cushion. Accordingly, a distance in the thickness direction of the seat back between the main frame member and the secondary frame member is reduced, so that the thickness of the seat back can be increased or reduced. This allows the thickness of the seat back to be increased or reduced in rotating the seat back with respect to the seat cushion not only at the time of tilting the seat back forward and returning the seat back from the forward tilt.

A seat structure according to claim 2 comprises: a main frame member provided in a seat back; an extending/retracting unit including a secondary frame member provided at a surface side or a back side of the main frame member in the seat back and a link rotatably connected to the main frame member and the secondary frame member; and an operation mechanism connected to the extending/retracting unit, wherein the operation mechanism is operated independently from a rotation of the seat back with respect to the seat cushion and rotates the link.

In the seat structure according to claim 2, the main frame member is provided in the seat back. Further, the extending/retracting unit includes the secondary frame member and the link. The secondary frame member is provided at the surface side or the back side of the main frame member in the seat back while the link is rotatably connected to the main frame member and the secondary frame member.

In the above case, the operation mechanism is connected to the extending/retracting unit. The operation mechanism is operated independently from the rotation of the seat back with respect to the seat cushion and rotates the link. Accordingly, a distance in the thickness direction of the seat back between the main frame member and the secondary frame member is increased or reduced, so that the thickness of the seat back can be increased or reduced. This allows the thickness of the seat back to be increased or reduced in operating the operation mechanism (other than the time of tilting the seat back forward and returning the seat back from the forward tilt)

A seat extension/retraction method in accordance with claim 7 comprises: in a seat structure comprising a main frame member provided in a seat back and an extending/retracting unit including a secondary frame member provided at a surface side or a back side of the main frame member in the seat back, and a link rotatably connected to the main frame member and the secondary frame member, and a link mechanism connected to a seat cushion and the extending/retracting unit, the method wherein rotating the link together with a rotation of the seat back with respect to the seat cushion.

A vehicle in accordance with claim 12 is provided with a seat using the seat structure according to claim 1.

### BRIEF DESCRIPTION OF THE DRAWINGS

FIG. 1 is a left side view of an integral part of a seat in accordance with Embodiment 1 of the invention.

FIG. 2 is a left side view of a seat in accordance with Embodiment 1 of the invention.

FIG. 3A is a plan view from the top side, the view showing an inside of a seat back of a seat in accordance with Embodiment 1 of the invention in a state of ordinary use of the seat.

FIG. 3B is a plan view from the top side, the view showing an inside of a seat back of a seat in accordance with Embodiment 1 of the invention in a state of stowage of the seat.

FIG. 4 is a left side view showing a state of tumble-storage of the seat in accordance with Embodiment 1 of the invention.

FIG. 5 is a perspective view from the obliquely front side, the view showing a state of space-increasing storage of the seat in accordance with Embodiment 1 of the invention.

FIG. 6 is a perspective view from the obliquely rear side, the view showing a state of rear-side under-floor storage of the seat in accordance with Embodiment 1 of the invention.

FIG. 7 is a left side view of a seat in accordance with Embodiment 2 of the invention.

FIG. 8 is a perspective view from the obliquely front side, the view showing a state of space-increasing storage of the seat in accordance with Embodiment 2 of the invention.

FIG. 9 is a left side view of an integral part of a seat in accordance with Embodiment 3 of the invention.

FIG. 10 is a left side view of an integral part of a seat in accordance with Embodiment 4 of the invention.

FIG. 11 is a left side view of a seat in accordance with Embodiment 4 of the invention in states of ordinary use and forward-tilt stowage of the seat.

FIG. 12 is a left side view of a seat in accordance with Embodiment 4 of the invention in states of ordinary use and double-folded stowage of the seat.

FIG. 13 is a perspective view from the obliquely rear side, the view showing a state of double-folded stowage of the seat in accordance with Embodiment 4 of the invention.

FIG. 14 is a left side view of an integral part of a seat in accordance with Embodiment 5 of the invention.

### BEST MODE FOR CARRYING OUT THE INVENTION

### Embodiment 1

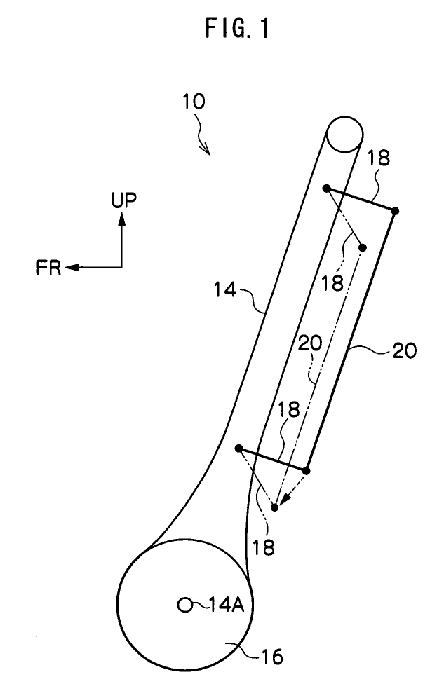

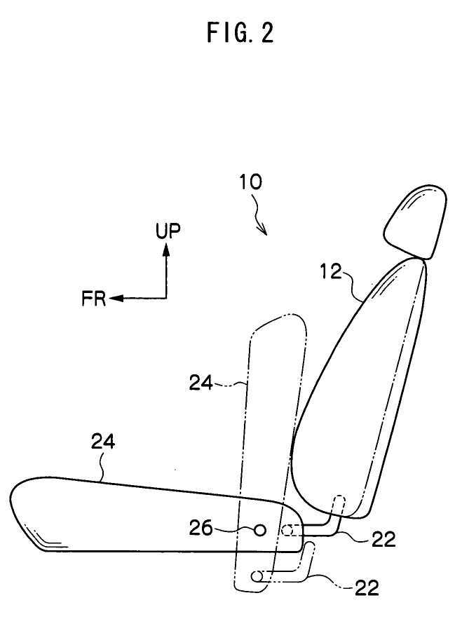

FIG. 1 is a left side view of an integral part of a seat 10 in accordance with Embodiment 1 of the invention, the seat 10 arranged so that a seat structure in accordance with the invention would be applied to. FIG. 2 is a left side view of the seat 10. In the drawings, an arrow FR shows a forward direction of the seat 10 while an arrow UP shows an upper direction of the seat 10.

The seat 10 in accordance with Embodiment 1 is for a vehicle and provided on a vehicle compartment floor surface of the vehicle. The seat 10 is a so-called tipup stowage type seat.

The seat 10 is provided with a seat back 12. Inside both of the right and left ends of the seat back 12, provided is a plate-shaped back main frame 14 (a side frame) as a main frame member. Supporting a lower end of the back main frame 14 on a vehicle body so as to be rotatable upon a rotation center shaft 14A allows the seat back 12 to be supported on the vehicle body so as to be rotatable upon the rotation center shaft 14A. At the lower end of the back main frame 14, provided is a reclining mechanism 16. The reclining mechanism 16 stops a rotation of the back main frame 14 upon the rotation center shaft 14A to stop a rotation of the seat back 12 upon the rotation center shaft 14A, so that the seat back 12 is raised substantially perpendicularly. Further, operating the reclining mechanism 16 causes the reclining mechanism 16 to allow the back main frame 14 to rotate upon the rotation center shaft 14A, and thereby, the seat back 12 to rotate upon the rotation center shaft 14A.

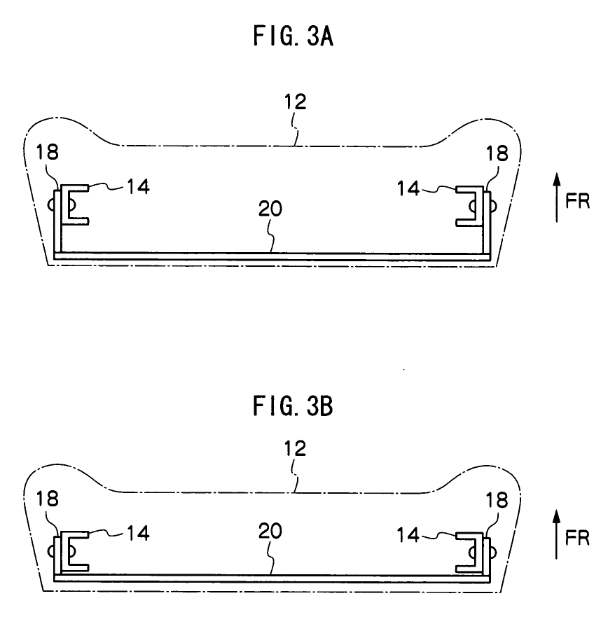

The back main frame 14 is rotatably connected to front ends of a fixed number of (two in Embodiment 1) connection links 18, which are links forming an extending/retracting unit (refer to FIG. 3A).

In the seat back 12, provided is a receiving member 20 in the shape of a flat plate, which is used as a secondary frame member forming the extending/retracting unit, at an end on the rear side (the back side) of the back main frame 14. The receiving member 20 is rotatably connected to rear ends of the connection links 18 (refer to FIG. 3A).

An upper end of an L-shaped interlocking link 22, which functions as a link mechanism, is rotatably connected to both of the right and left ends of a lower end of the receiving member 20 or rear ends (any part other than the front ends) of the connection links 18 at the lower part of the back main frame 14. The upper end of the interlocking link 22 (a rotation center shaft) is offset with respect to the rotation center shaft 14A provided at the lower end of the back main frame 14.

On the front side of the seat back 12, provided is a seat cushion 24. The vicinity of the rear end of the seat cushion 24 is supported at both of the right and left ends thereof on the vehicle body so as to be rotatable upon a supporting shaft 26. This allows the seat cushion 24 to be supported on the vehicle body rotatably upon the supporting shaft 26. The rear end of the seat cushion 24 is in contact with a lower end of the seat back 12, so that the seat cushion 24 is arranged substantially horizontally. Moreover, a lower side end of the interlocking link 22 is rotatably connected to both of the right and left ends of the seat cushion 24 at the rear end thereof on the rear side of the supporting shaft 26.

Now, described will be an operation of Embodiment 1.

In the seat 10 having the above structure, rotating the seat cushion 24 rearward upon the supporting shaft 26 (tipping up the seat cushion 24) causes the seat cushion 24 to be raised and superposed on the front side of the seat back 12 for stowage.

In the stowage of the seat 10, the seat cushion 24 is rotated rearward upon the supporting shaft 26, moving the interlocking link 22 downward. The receiving member 20 or the connection link 18 is then moved downward in accordance with the above to rotate the connection link 18 downward, so that the distance in the back-and-forth direction (a direction of the thickness of the seat back 12) between the back main frame 14 and the receiving member 20 is reduced (refer to FIG. 3B) This allows the thickness of the seat back 12 to be reduced in a part on the back of the back main frame 14 even in the case that the thickness of the seat back 12 in normal use is increased. Accordingly, a space of a vehicle compartment (a baggage compartment) (a space on the front side and the rear side of the seat 10) in stowing the seat 10 can be increased.

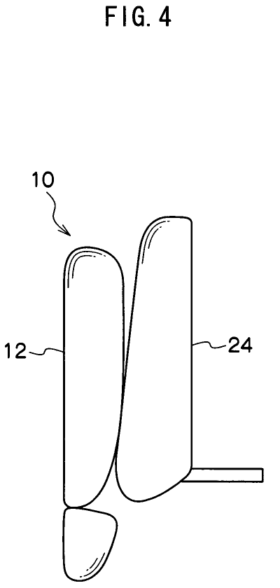

Further, as shown in FIG. 4, for example, the seat 10 may be formed into a so-called tumble storage type so that support of the seat back 12 and the seat cushion 24 on the vehicle body would be released after stowage of the seat 10 to rotate the seat 10 forward by substantially 90 degrees, and thereby, to store the seat 10 (the seat back 12 and the seat cushion 24) forward in a state that the seat 10 is raised substantially perpendicularly. In this case, a space of a vehicle compartment (a baggage compartment) (a space on the front side and the rear side of the seat 10) in storing the seat 10 can be increased since the seat back 12 is reduced in thickness in accordance with the stowage of the seat 10 as described above.

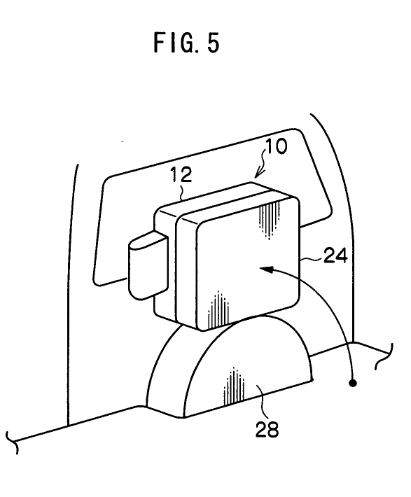

Moreover, as shown in FIG. 5, for example, in the case that a wheel house 28 is provided on a side of the seat 10, the seat 10 may be formed into a so-called space-increasing storage type so that support of the seat back 12 and the seat cushion 24 on the vehicle body would be released after stowage of the seat 10 to rotate the seat 10 forward and laterally by substantially 90 degrees, and thereby, to store the seat 10 (the seat back 12 and the seat cushion 24) on the upper side of the wheel house 28 in a state that the seat 10 is raised substantially perpendicularly. In this case, a space of a vehicle compartment (a baggage compartment) (a space on a side of the seat 10) in storing the seat 10 can be increased since the seat back 12 is reduced in thickness in accordance with the stowage of the seat 10 as described above.

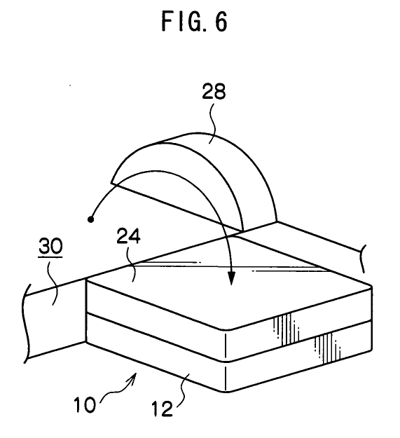

Furthermore, as shown in FIG. 6, for example, in the case that a concave 30 exists on the rear side of the seat 10, the seat 10 may be formed into a so-called rear-side under-floor storage type so that support of the seat back 12 and the seat cushion 24 on the vehicle body would be released after stowage of the seat 10 to rotate the seat 10 rearward by substantially degrees, and thereby, to store the seat 10 (the seat back and the seat cushion 24) substantially horizontally in the concave 30 in a state that the seat cushion 24 is arranged to be on the upper side of the seat back 12. In this case, a space of a vehicle compartment (a baggage compartment) (a space on the upper side of the seat 10) in storing the seat 10 can be increased while the concave 30 can be shallowed since the seat back 12 is reduced in thickness in accordance with the storage of the seat 10 as described above.

### Embodiment 2

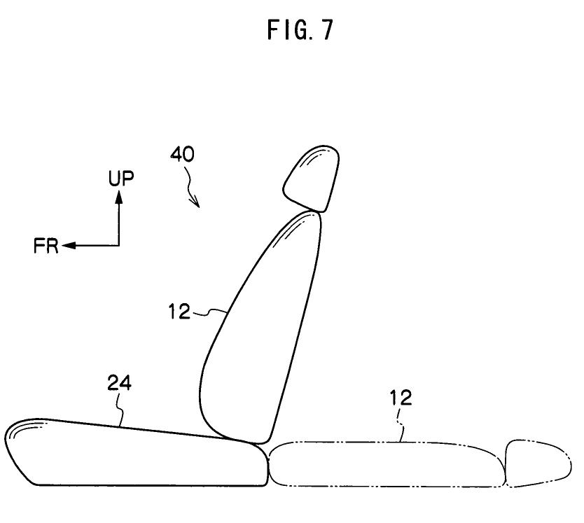

FIG. 7 is a left side view of a seat 40 in accordance with Embodiment 2, the seat 40 being arranged so that a seat structure in accordance with the invention would be applied to.

The seat 40 in accordance with Embodiment 2 is almost same in structure as Embodiment 1 but different in that it is of a so-called back rearward-tilt stowage type.

Now, described will be an operation of Embodiment 2. In the seat 40 having the above structure, operating the reclining mechanism 16 to rotate the seat back 12 rearward upon the rotation center shaft 14A causes the seat back 12 to be substantially horizontally arranged on the back of the seat cushion 24 and stowed.

In the stowage of the seat 40, the seat back 12 is rotated rearward upon the rotation center shaft 14A, rotating the interlocking link 22 downward. The receiving member 20 or the connection link 18 is then moved to an upper end side of the seat back 12 or to a lower end side of the seat back 12 in accordance with the above to rotate the connection link 18 to the upper end side of the seat back 12 or to the lower end side of the seat back 12, so that the distance in the direction of the thickness of the seat back 12 between the back main frame 14 and the receiving member 20 is reduced. This allows the thickness of the seat back 12 to be reduced in a part on the back of the back main frame 14 even in the case that the thickness of the seat back 12 in normal use is increased. Accordingly, a space of a vehicle compartment (a baggage compartment) (a space on the upper side of the seat back 12) in stowing the seat 40 can be increased.

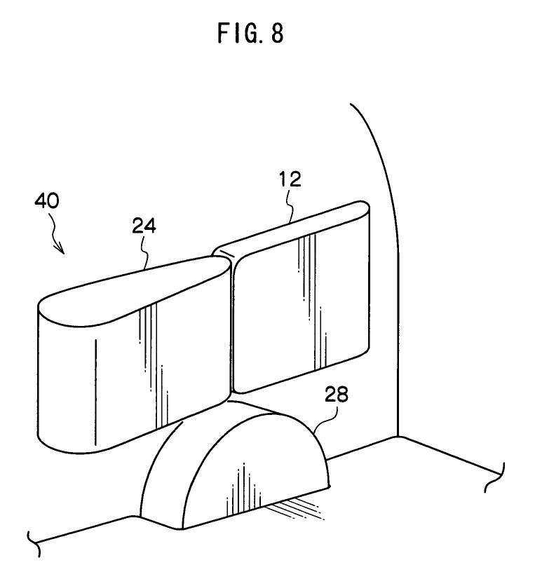

Further, as shown in FIG. 8, for example, in the case that a wheel house 28 is provided on a side of the seat 40, the seat 40 may be formed into a so-called space-increasing storage type so that support of the seat back 12 and the seat cushion 24 on the vehicle body would be released after stowage of the seat 40 to rotate the seat 40 laterally by substantially degrees, and thereby, to store the seat 40 (the seat back and the seat cushion 24) on the upper side of the wheel house 28 in a state that the seat 40 is raised substantially perpendicularly. In this case, a space of a vehicle compartment (a baggage compartment) (a space on a side of the seat back 12) in storing the seat 40 can be increased since the seat back 12 is reduced in thickness in accordance with the stowage of the seat 40 as described above.

### Embodiment 3

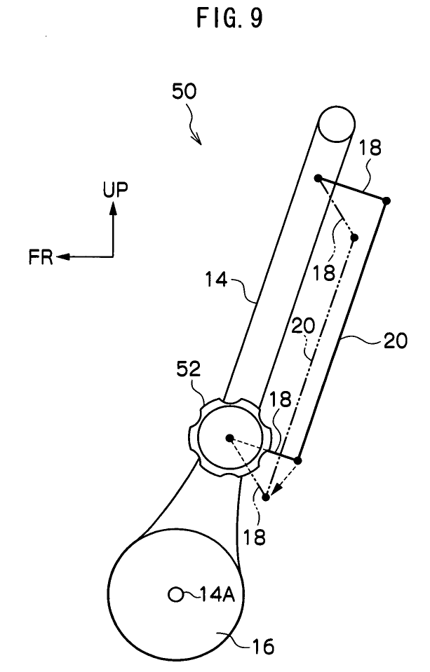

FIG. 9 is a left side view of an integral part of a seat 50 in accordance with Embodiment 3, the seat 50 being arranged so that a seat structure in accordance with the invention would be applied to.

The seat 50 in accordance with Embodiment 3 is almost same in structure as Embodiment 1 but different in the following point.

In the case of the seat 50 in accordance with Embodiment 3, a front end (a rotation center) of one of the interlocking links 18 of the back main frame 14 is connected to a columned operation lever 52 functioning as an operation mechanism. The operation lever 52 is formed from a dial type regulator or such. The operation lever 52 is provided with a rotation locking mechanism (not shown) functioning as a locking mechanism. The rotation locking mechanism interrupts a rotation of the operation lever 52. The operation lever 52 projects to a side of the seat back 12. An operation of rotating the operation lever 52 allows the connection link 18 to be rotated.

Further, in Embodiment 3, provided is no interlocking link 22 in accordance with Embodiment 1.

Now, described will be an operation of Embodiment 3.

In the seat 50 having the above structure, the operation lever 52 is operated for a rotation with the interruption of a rotation by the rotation locking mechanism of the operation lever 52 being released to rotate the connection link 18. This causes the distance in the back-and-forth direction (a direction of the thickness of the seat back 12) between the back main frame 14 and the receiving member 20 to be increased or reduced. Accordingly, the thickness of the seat back 12 can be increased or reduced on the back of the back main frame 14 independently from the stowage of the seat 50. This allows an elastically deformable quantity to the rear side of the seat back 12 (a back stroke quantity) to be adjusted correspondingly to a difference in build (a difference in weight) of an occupant sitting on the seat 50.

### Embodiment 4

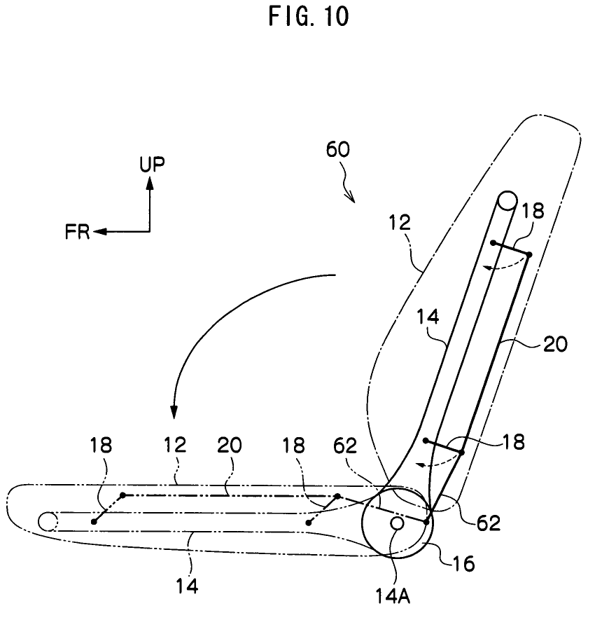

FIG. 10 is a left side view of an integral part of a seat 60 in accordance with Embodiment 4, the seat 60 being arranged so that a seat structure in accordance with the invention would be applied to.

The seat 60 in accordance with Embodiment 4 is almost same in structure as Embodiment 1 but different in the following point.

The seat 60 is of a so-called back forward-tilt stowage type.

Both of the right and left ends of a lower end of the receiving member 20 or rear ends (any part other than the front ends) of the connection links 18 at the lower part of the back main frame 14 are rotatably connected to an upper end of a support link 62 instead of the interlocking link 22 in accordance with Embodiment 1. The upper end of the support link 62 (a rotation center shaft) is offset with respect to the rotation center shaft 14A provided at the lower end of the back main frame 14. A lower end of the support link 62 is rotatably connected to the vehicle body. The lower end of the support link 62 (a rotation center shaft) is offset to the rear side with respect to the rotation center shaft 14A provided at the lower end of the back main frame 14.

Now, described will be an operation of Embodiment 4.

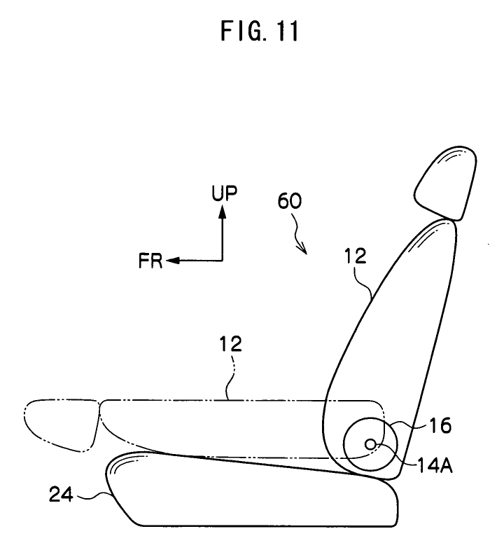

In the seat 60 having the above structure, as shown in FIG. 11, operating the reclining mechanism 16 to rotate the seat back 12 forward upon the rotation center shaft 14A causes the seat back 12 to be superposed on the upper side of the seat cushion 24 to be stowed (so-called forward-tilt stowage).

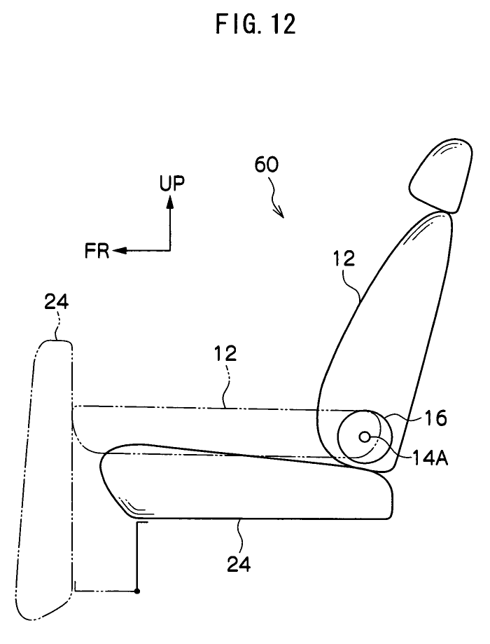

Otherwise, as shown in FIG. 12, support of the seat cushion 24 on the vehicle body is released to rotate the seat cushion 24 forward, and thereby, to raise the seat cushion 24 substantially perpendicularly. Operating the reclining mechanism 16 to rotate the seat back 12 forward upon the rotation center shaft 14A after the above causes the seat back 12 to be substantially horizontally arranged on the back of the seat cushion 24 and stowed (so-called double-folded stowage).

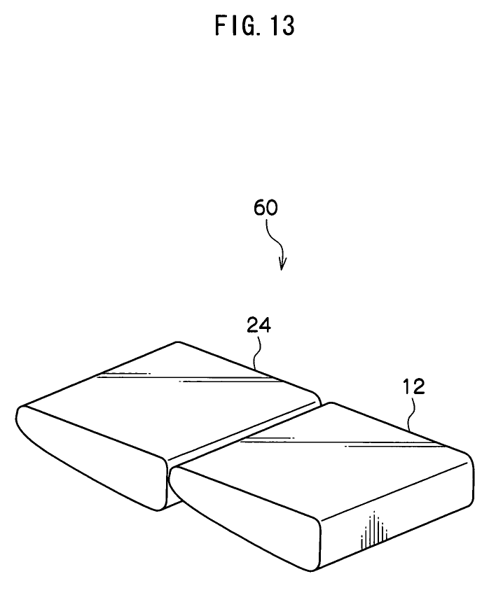

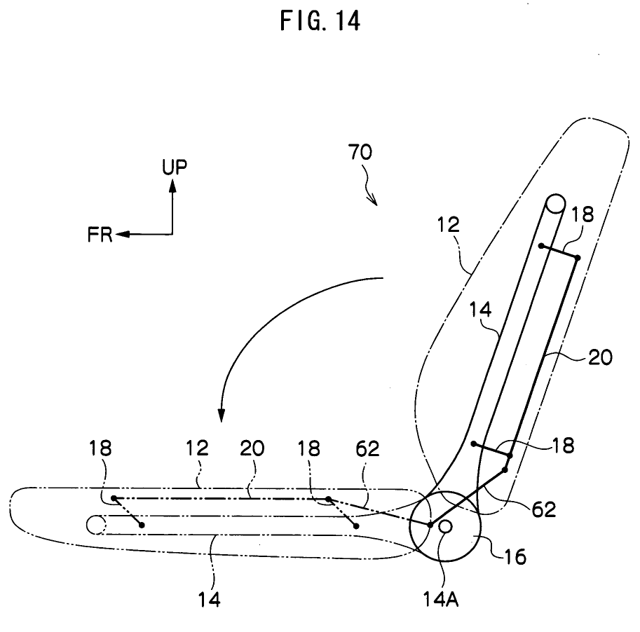

Moreover, as shown in FIG. 13, support of the seat cushion 24 on the vehicle body is released to rotate the seat cushion 24 forward, and thereby, to rotate over the seat cushion 24 substantially horizontally. Operating the reclining mechanism 16 to rotate the seat back 12 forward upon the rotation center shaft 14A after the above causes the seat back to be substantially horizontally arranged on the back of the seat cushion 24 and stowed (so-called double-flat stowage).

In the stowage of the seat 60, the seat back 12 is rotated forward upon the rotation center shaft 14A, moving the support link 62 to a lower end side of the seat back 12. The receiving member 20 or the connection link 18 is then moved to the lower end side of the seat back 12 in accordance with the above to rotate the connection link 18 to the lower end side of the seat back 12, so that the distance in the back-and-forth direction (the direction of the thickness of the seat back 12) between the back main frame 14 and the receiving member 20 is reduced. This allows the thickness of the seat back 12 to be reduced in a part on the back of the back main frame 14 even in the case that an increase in thickness of the seat back 12 in normal use is required (concretely, in the case of requirement of the feel of a substance or the feel of bulkiness). Accordingly, a space of a vehicle compartment (a baggage compartment) (a space on the upper side of the seat back 12) in stowing the seat 60 can be increased while interference of the seat back 12 with a vehicle compartment floor surface can be prevented from occurring.

Further, similarly to FIG. 4, for example, the seat 60 may be formed into a so-called tumble storage type so that support of the seat back 12 and the seat cushion 24 on the vehicle body would be released after forward-tilt stowage of the seat 60, as shown in FIG. 11, to rotate the seat 60 forward by substantially 90 degrees, and thereby, to store the seat 60 (the seat back 12 and the seat cushion 24) forward in a state that the seat 60 is raised substantially perpendicularly. In this case, a space of a vehicle compartment (a baggage compartment) (a space on the front side and the rear side of the seat 60) in storing the seat 60 can be increased since the seat back 12 is reduced in thickness in accordance with the stowage of the seat 60 as described above.

In addition, similarly to FIG. 5, for example, in the case that a wheel house 28 is provided on a side of the seat 60, the seat 60 may be formed into a so-called space-increasing storage type so that support of the seat back 12 and the seat cushion 24 on the vehicle body would be released after forward-tilt stowage of the seat 60, as shown in FIG. 11, to rotate the seat 60 laterally by substantially 90 degrees, and thereby, to store the seat 60 (the seat back 12 and the seat cushion 24) on the upper side of the wheel house 28 in a state that the seat 60 is raised substantially perpendicularly. In this case, a space of a vehicle compartment (a baggage compartment) (a space on a side of the seat 60) in storing the seat 60 can be increased since the seat back 12 is reduced in thickness in accordance with the stowage of the seat 60 as described above.

Besides, similarly to FIG. 6, for example, in the case that a concave 30 exists on the rear side of the seat 60, the seat 60 may be formed into a so-called rear-side under-floor storage type so that support of the seat back 12 and the seat cushion 24 on the vehicle body would be released after forward-tilt stowage of the seat 60, as show in FIG. 11, to rotate the seat 60 rearward by substantially 180 degrees, and thereby, to store the seat 60 (the seat back 12 and the seat cushion 24) substantially horizontally in the concave 30 in a state that the seat cushion 24 is arranged to be on the upper side of the seat back 12. In this case, a space of a vehicle compartment (a baggage compartment) (a space on the upper side of the seat 60) in storing the seat 60 can be increased while the concave 30 can be shallowed since the seat back 12 is reduced in thickness in accordance with the stowage of the seat 60 as described above.

### Embodiment 5

FIG. 11 is a left side view of an integral part of a seat 70 in accordance with Embodiment 5, the seat 70 being arranged so that a seat structure in accordance with the invention would be applied to.

The seat 70 in accordance with Embodiment 5 is almost same in structure as Embodiment 4 but different in the following point.

In the case of the seat 70 in accordance with Embodiment 5, a lower end (a rotation center shaft) of the support link 62 is offset to the front side with respect to the rotation center shaft 14A provided at the lower end of the back main frame 14.

In this case, the support link 62 is moved to the upper end side of the seat back 12 when the reclining mechanism 16 is operated to rotate the seat back 12 forward upon the rotation center shaft 14A. This causes the receiving member 20 or the connection link 18 to be moved to the upper side of the seat back 12, and thereby, the connection link 18 to be rotated to the upper side of the seat back 12. Accordingly, the distance in the back-and-forth direction (the direction of the thickness of the seat back 12) between the back main frame 14 and the receiving member 20 is reduced.

This allows an effect similar to that of Embodiment 4, which has been described above, to be achieved even in Embodiment 5.

### INDUSTRIAL APPLICABILITY

In accordance with Embodiments 1 and 2, the lower end side of the interlocking link 22 is arranged to be rotatably connected to the seat cushion 24 on the back side of the support shaft 26. The lower end of the interlocking link 22, however, may be arranged to be rotatably connected to the seat cushion 24 on the front side of the support shaft 26.

Further, in Embodiments 4 and 5, the seats 60 and 70, which are to be forward-tilt stowed, may be arranged to be of a so-called tilt-down stowage type so that the seat cushion 24 would be moved downward in accordance with a forward rotation of the seat back 12 upon the rotation center shaft 14A.

Moreover, the receiving member 20 and the connection links 18 is arranged to be provided on the rear side (the back side) of the back main frame 14 in the seat back 12 in Embodiments 1 to 5. The receiving member 20 and the connection links 18, however, may be arranged to be provided on the front side (the surface side) of the back main frame 14 in the seat back 12.

1-12. (canceled)

13. A seat structure comprising:
a main frame member provided in a seat back;
an extending/retracting unit including a secondary frame member provided at a back side of the main frame member in the seat back and a link rotatably connected to the main frame member and the secondary frame member; and
a link mechanism connected to a seat cushion and the extending/retracting unit, whereby the link is rotated together with a rotation of the seat cushion in a raising direction.

14. The seat structure according to claim 13, wherein the link mechanism is a connection link rotatably connected to the seat cushion and the extending/retracting unit.

15. The seat structure according to claim 13, wherein the seat cushion is able to rotate rearward from a position of use.

16. The seat structure according to claim 13, wherein the seat back is able to rotate rearward from a position of use.

17. The seat structure according to claim 13, wherein the seat back is able to rotate forward from a position of use.

18. A seat structure comprising:
a main frame member provided in a seat back;
an extending/retracting unit including a secondary frame member provided at a back side of the main frame member in the seat back and a link rotatably connected to the main frame member and the secondary frame member; and
an operation mechanism connected to the extending/retracting unit, wherein the operation mechanism is operated independently from a rotation of the seat back with respect to the seat cushion and rotates the link.

19. A seat extending/retraction method in a seat structure comprising a main-frame member provided in a seat back and an extending/retracting unit including a secondary frame member provided at a back side of the main frame member in the seat back, and a link rotatably connected to the main frame member and the secondary frame member, and a link mechanism connected to a seat cushion and the extending/retracting unit, the method comprising:
rotating the link together with a rotation of the seat cushion in a raising direction.

20. The method of extending/retracting a seat according to claim 19, wherein the link mechanism is a connection link rotatably connected to the seat cushion and the extending/retracting unit.

21. The method of extending/retracting a seat according to claim 19, wherein the seat cushion is able to rotate rearward from a position of use.

22. The method of extending/retracting a seat according to claim 19, wherein the seat back is able to rotate rearward from a position of use.

23. The method of extending/retracting a seat according to 19, wherein the seat back is able to rotate forward from a position of use.

24. A vehicle provided with a seat using the seat structure according to claim 13.
